(19) United States
(12) Patent Application Publication
(10) Pub. No.: US 2026/0202690 A1
(43) Pub. Date: Jul. 16, 2026

(54) SPORTY SMART SUNGLASSES

(71) Applicant: SOLOS TECHNOLOGY (SHENZHEN) LIMITED, Shenzhen (CN)

(72) Inventors: Chiu Ming So, Shenzhen (CN); Wai Kuen Kenny Cheung, Shenzhen (CN); Kwok Wah Law, Shenzhen (CN); Tsz Fung Lo, Shenzhen (CN)

(21) Appl. No.: 19/560,179

(22) Filed: Mar. 9, 2026

Related U.S. Application Data
(63) Continuation of application No. PCT/CN2024/114320, filed on Aug. 23, 2024.

(30) Foreign Application Priority Data
Sep. 8, 2023 (CN) 202322454999.4

(51) Int. Cl. G02C 11/00; G02C 5/02; G02C 5/12; G02C 5/14; G02C 7/10

(52) U.S. Cl. CPC G02C 11/10; G02C 5/02; G02C 5/12; G02C 5/14; G02C 7/10

(57) ABSTRACT

The present disclosure discloses sporty smart sunglasses, including a frame, temples, and a curved lens. An electronic module for realizing the functions of smart glasses is mounted in the frame and/or temples, and the curved lens has a sun-shading function. The curved lens includes a first lens and a second lens, which are of an integral structure. The curved lens is mounted on the frame via a snap-fit structure. Due to the integrated structure of the curved lens, there is no gap at the position of the curved lens corresponding to the space between the two eyes. Meanwhile, the curved lens is arcuate with its two sides bending inwards relative to the middle position, which can better fit and cover the lateral areas of the two eyes and thus provide comprehensive shielding for both eyes. These sporty smart sunglasses integrate functions of smart glasses and sunglasses.

### CROSS-REFERENCE TO RELATED APPLICATIONS

The present application is a Continuation Application of PCT Application No. PCT/CN2024/114320, filed on August 23, 2024, which claims priority of Chinese Patent Application No. 202322454999.4 filed on September 8, 2023, the entire contents of which are hereby incorporated by reference.

### TECHNICAL FIELD

This disclosure belongs to the field of smart eyewear, and in particular relates to sporty smart sunglasses.

### BACKGROUND

Sunglasses are a type of eyewear primarily performing a sun-shading function. When worn outdoors, sunglasses block uncomfortable strong light, prevent visual disturbance, and simultaneously protect the eyes from ultraviolet radiation. Conventional sunglasses feature a relatively small curvature (i.e., flat) in the front frame and adopt a double-lens structure. When worn for outdoor activities (such as running, hiking, or cycling), such sunglasses fail to block sunlight, which can easily enter the eyes from the lenses’ peripheries and the gap between the two separate lenses, thus compromising the sun-shading effect and the eye protection performance of the sunglasses. Furthermore, for users with vision impairments such as myopia or hyperopia who require correction, the eyewear is required to have both sun-shading and vision correction functions.

Smart glasses refer to wearable eyewear devices that, like smartphones, have an independent operating system and can realize various functions by integrating different software and functional modules. Smart glasses can access wireless networks via mobile communication networks, allowing users to perform operations such as adding schedules, map navigation, interacting with friends, taking photos and videos, making video calls, and playing music via voice or motion controls.

### SUMMARY

The objective of this disclosure is to provide sporty smart sunglasses that integrate the functions of smart glasses and can effectively protect the eyes at the same time.

This disclosure is realized as follows: sporty smart sunglasses, including a frame, temples, and curved lens, wherein an electronic module for realizing the smart glasses function is mounted in the frame and/or temples, the curved lens has a sun-shading function and includes a first lens and a second lens, the first lens and the second lens are of an integral structure, and the curved lens is mounted on the frame via a snap-fit structure.

Compared with the prior art, the present application has the following beneficial effects:

In the sporty smart sunglasses of the present application, the frame is mounted with an electronic module for realizing functions of smart glasses, and the curved lens has a sun-shading function. The curved lens is mounted on the outer surface of the frame via a snap-fit structure and is of an integrated structure, thus there is no gap at the position of the curved lens corresponding to the space between the two eyes. Meanwhile, the curved lens is arcuate with its two sides bending inwards relative to the middle position, which can better fit and cover the lateral areas of the two eyes. Thus, the curved lens can provide comprehensive shielding for both eyes and prevent ultraviolet rays of sunlight from entering the eyes.

The sporty smart sunglasses of the present application integrate the functions of smart eyewear and sunglasses, allowing users to enjoy music during outdoor activities, while also receiving better protection for both eyes, thereby enhancing the user's sports experience.

Furthermore, the sporty smart sunglasses of the present disclosure are provided with primary and auxiliary glasses. For users with vision impairments such as myopia or hyperopia who require correction, the primary glasses and the auxiliary glasses can be used in combination to meet the requirements of sun-shading and vision correction.

### BRIEF DESCRIPTION OF DRAWINGS

FIG. 1 is a structural schematic view of sporty smart sunglasses provided in Example 1 of this disclosure;

FIG. 2 is an exploded structural view of the sporty smart sunglasses shown in FIG. 1;

FIG. 3 is a structural schematic view of the frame in the sporty smart sunglasses shown in FIG. 1;

FIG. 4 is a schematic view of the frame shown in FIG. 3 from another perspective;

FIG. 5 is a structural schematic view of the sporty smart sunglasses provided in Example 1 of this disclosure before the hinge cable assembly is assembled;

FIG. 6 is a structural schematic view of the sporty smart sunglasses provided in Example 1 of this disclosure before the temples are assembled;

FIG. 7 is a structural schematic view of the sporty smart sunglasses provided in Example 1 of this disclosure after the temples are assembled;

FIG. 8 is a partial sectional schematic view of the sporty smart sunglasses provided in Example 1 of this disclosure before the temples are assembled;

FIG. 9 is a partial sectional schematic view of the sporty smart sunglasses provided in Example 1 of this disclosure after the temples are assembled;

FIG. 10 is a schematic view of the sporty smart sunglasses provided in Example 1 of this disclosure, where the nose pad is installed via a plug-in method;

FIG. 11 is a schematic view of the sporty smart sunglasses provided in Example 1 of this disclosure, where the nose pad is installed via a screw;

FIG. 12 is an exploded structural view of sporty smart sunglasses provided in Example 2 of this disclosure;

FIG. 13 is a structural schematic view showing the sporty smart sunglasses of FIG. 2 in another disassembled state;

FIG. 14 is a structural schematic view of the frame in the sporty smart sunglasses shown in FIG. 12;

FIG. 15 is a structural schematic view of sporty smart sunglasses provided in Example 3 of this disclosure;

FIG. 16 is an exploded structural view of the sporty smart sunglasses shown in FIG. 15;

FIG. 17 is a structural schematic view of the frame in the sporty smart sunglasses shown in FIG. 15;

FIG. 18 is an exploded structural view of the auxiliary glasses in the sporty smart sunglasses shown in FIG. 15; and

FIG. 19 is a structural schematic view of the auxiliary glasses in the sporty smart sunglasses shown in FIG. 15.

### DESCRIPTION OF EMBODIMENTS

To make the objectives, technical solutions, and advantages of this disclosure clearer, the following further describes this disclosure with reference to the accompanying drawings and the embodiments. It is to be understood that the specific embodiments described herein are merely used to explain this disclosure and are not intended to limit the scope of this disclosure.

In the description of the present disclosure, it is to be noted that the terms “center,” “up,” “down,” “left,” “right,” “front,” “back,” “vertical,” “horizontal,” “inside,” “outside,” etc. indicate orientations or positional relationships based on those shown in the accompanying drawings, and are intended only for the purpose of facilitating the description of the present disclosure and simplifying the description, and are not intended to indicate or imply that the device or element referred to must be constructed and operated with a particular orientation, and are not to be construed as a limitation of the present disclosure; the terms “first,” “second,” and “third,” are used for descriptive purposes only and are not to be understood as indicative or suggestive of relative importance; furthermore, the terms “mounting,” “connecting,” “connected” are to be understood in a broader sense unless otherwise expressly provided and qualified, e.g., as a fixed connection, a removable connection, or a connection in one piece, as a direct connection, as an indirect connection through an intermediate medium, or as a connection within two parts. For those of ordinary skill in the art, the specific meaning of the above terms in the present disclosure may be understood in specific contexts.

Example 1:

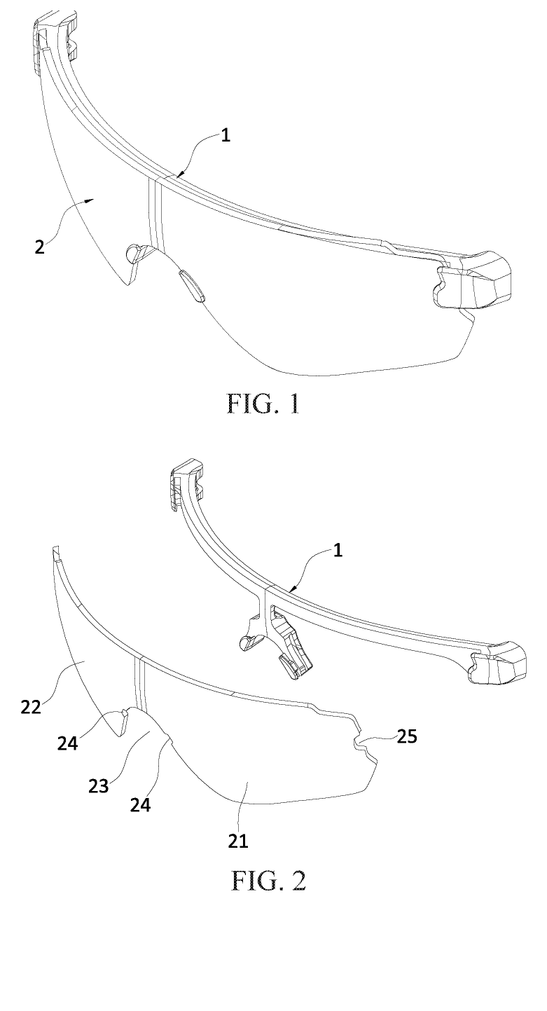

Please refer to FIGS. 1 and 2, which show sporty smart sunglasses provided in this embodiment, including a frame 1 and a curved lens 2. An electronic module for realizing the functions of smart glasses is mounted in the frame 1, and the curved lens 2 is mounted on the outer surface of the frame 1 via a snap-fit structure.

The curved lens 2 has a sun-shading function. The curved lens 2 includes a first lens 21 and a second lens 22, which are of an integral structure. In practical applications, the curved lens 2 can be an anti-reflective lens, a colored lens, a tinted lens, a polarized lens, or a photochromic lens.

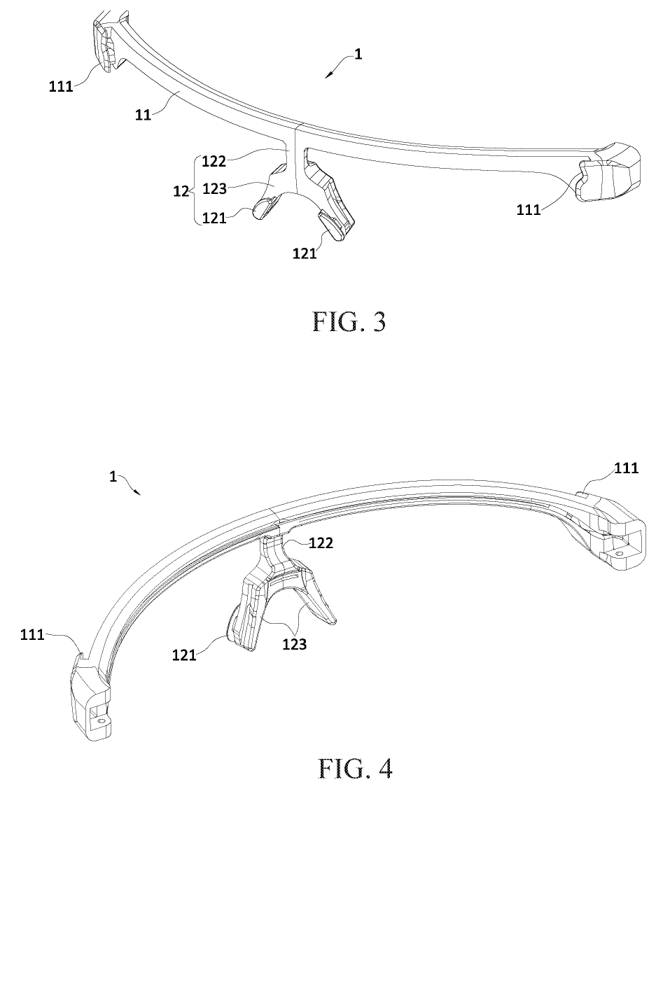

Specifically, please refer to FIGS. 3 and 4. The frame 1 includes an arched rim 11. A bridge 12 extends downward from the middle portion of the arched rim 11. The outer surface of the bridge 12 is provided with a lens snap-fit 121. Please refer to FIG. 2 again, a relief notch 23 for avoiding the nose is defined at the bottom of the middle portion of the curved lens 2. Lower recesses 24 are defined on both left and right side edges of the relief notch 23. The lower recesses 24 of the curved lens 2 are snap-fitted to the lens snap-fits 121 of the bridge 12.

The outer surfaces of the left and right ends of the arched rim 11 are respectively provided with snap-fit retainers 111, and upper recesses 25 are respectively defined on the left and right side edges of the curved lens 2. The upper recesses 25 on the left and right sides of the curved lens 2 are respectively snap-fitted to the snap-fit retainers 111 at the left and right ends of the arched rim 11.

When the lower recess 24 and upper recess 25 of the curved lens 2 are pressed into the lens snap-fit 121 and snap-fit retainer 111 of the frame 1, respectively, the curved lens 2 is located on the outer side of the arched rim 11 after assembly.

The arched rim 11 is contoured to match the head, and its curvature is the same as that of the curved lens 2.

Since there is no gap at the position of the curved lens 2 corresponding to the area between the two eyes, and the curved lens 2 has an arcuate shape with its two sides being curved inward relative to the middle position, it can better fit and cover the lateral areas of both eyes. Thus, the curved lens 2 can provide comprehensive shielding for both eyes, preventing ultraviolet rays of sunlight from entering the eyes.

Specifically, the bridge 12 includes a connecting section 122 and two branch sections 123. The two branch sections 123 respectively extend outward from the bottom end of the connecting section 122, and the space defined by the two branch sections 123 is shaped to match the relief notch 23, so as to provide clearance for a nose. Lens snap-fits 121 are respectively disposed on outer sides of bottom ends of the two branch sections 123.

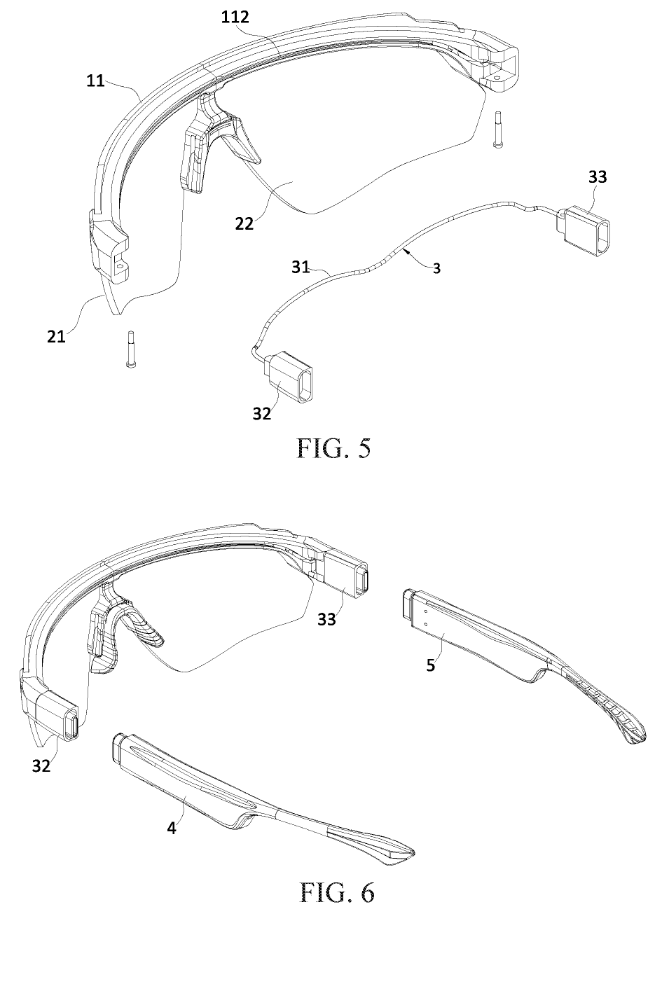

Further, referring to FIG. 5, the sporty smart sunglasses of this example further include a hinge cable assembly 3 and a decorative strip. A cable receiving groove 112 is defined on the inner surface of the arched rim 11. The decorative strip is configured to cover the cable receiving groove 112, so as to seal the hinge cable assembly 3 and achieve a decorative effect. The hinge cable assembly 3 includes a cable 31, a left hinge 32 fixedly connected to the left end of the cable 31, and a right hinge 33 fixedly connected to the right end of the cable 31. The cable 31 is embedded in the cable receiving groove 112. The cable 31 may be an FPC, a 4-core seven-layer sheathed cable, and an 8-core seven-layer sheathed cable, or the like, and can transmit power, control signals and data signals. The left hinge 32 is hinged to the left end of the arched rim 11, and the right hinge 33 is hinged to the right end of the arched rim 11, so that both the left hinge 32 and the right hinge 33 can swing leftward and rightward relative to the arched rim 11.

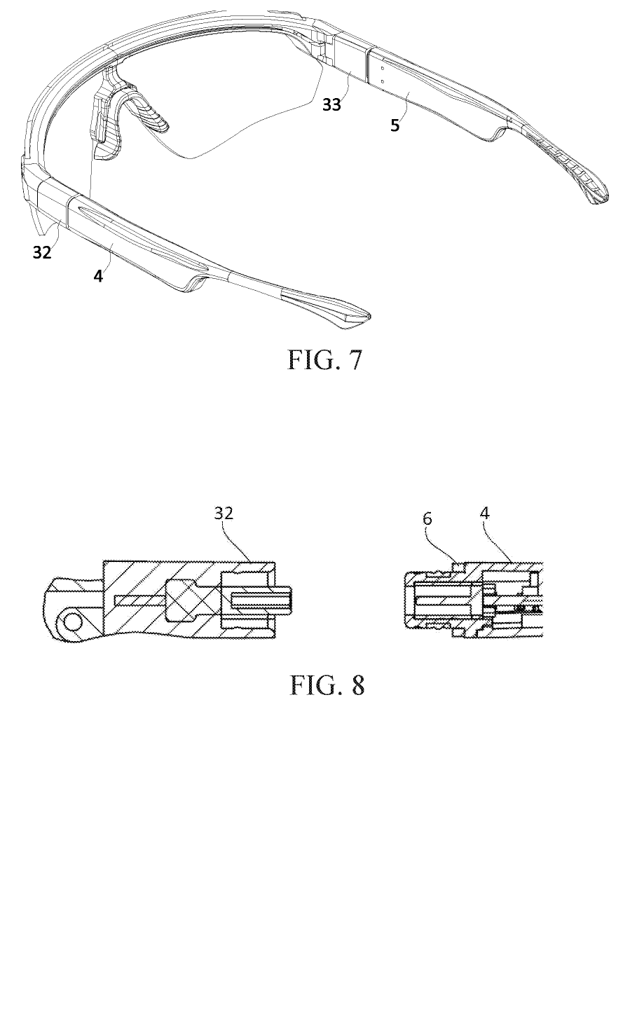

The electronic module in the present example may be directly integrated into the frame 1, or may be mounted in an indirect manner. In this example, please refer to FIGS. 6 and 7, the sporty smart sunglasses further include a left temple 4 and a right temple 5. The electronic module is mounted in the left temple 4 and/or the right temple 5. For example, a battery may be embedded in the left temple 4 to supply power to the smart glasses, and electronic components such as MCU, sensors, Bluetooth chips, etc. may be embedded in the right temple 5 to provide functions of smart glasses.

An insertion end of the left temple 4 is inserted into an insertion slot of the left hinge 32, and an insertion end of the right temple 5 is inserted into an insertion slot of the right hinge 33. Since the temples are detachably connected to the frame 1, the frame 1 and temples of different generations or styles are interchangeable. A user may upgrade the smart sunglasses by replacing the temples with the latest version; that is, the frame 1 remains the same, while the temples can be replaced from a first generation to a second or third generation. A user may also replace the frame 1 with different styles while using the same temples, i.e., the same temples can be matched with a fashionable blue-light blocking frame for working, and matched with a sunshade frame for sports or outdoor activities.

The insertion ends of the left temple 4 and right temple 5 may be plug ends such as USB Type-C connectors, Pogo Pin connectors, or other types of connectors. The left hinge 32 and right hinge 33 may be board-to-board connectors, solder wires, etc. Different types of connectors may be used to connect the temples and the frame 1 together.

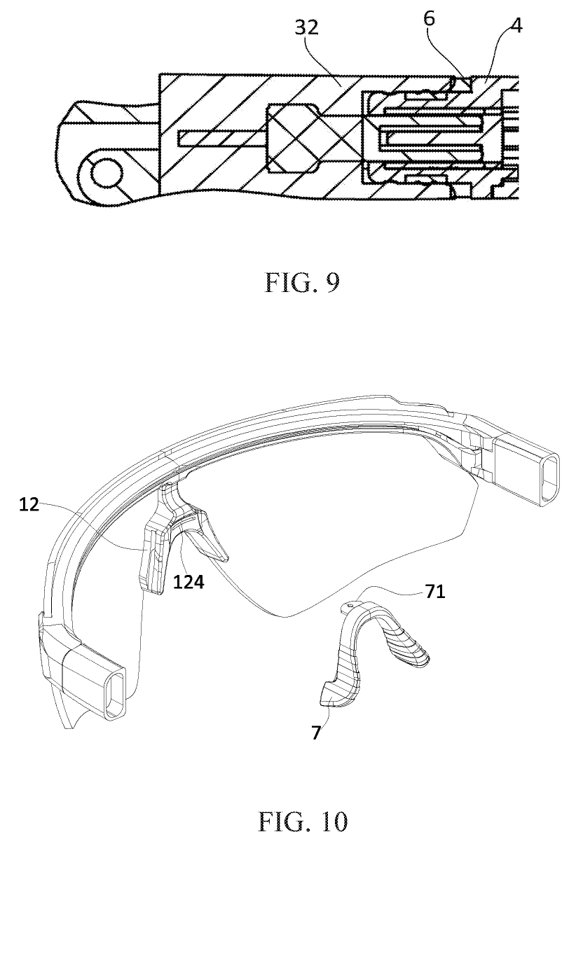

Please refer to FIGS. 8 and 9, a left sealing ring 6 is wrapped around the outer periphery of the insertion end of the left temple 4, and the outer periphery of the left sealing ring 6 is in close contact with the inner wall of the insertion slot of the left hinge 32. A right sealing ring is wrapped around the outer periphery of the insertion end of the right temple 5, and the outer periphery of the right sealing ring is in close contact with the inner wall of the socket of the right hinge 33. Preferably, both the left and right sealing rings are rubber sealing rings. The rubber sealing ring may be fixed to the outer periphery of the insertion end of the temple by over-molding, two-shot molding, elastic clamping, or the like. Since the connection portions between the hinges and the temples are wrapped by the rubber sealing ring, a waterproof and dustproof effect can be achieved. Furthermore, the rubber sealing ring is directly molded around the hinge, forming a protruding shape. Two grooves are respectively defined on two sides of the rubber sealing rings. When the temple is inserted into the hinge, the rubber sealing ring expands into the groove without squeezing the temple.

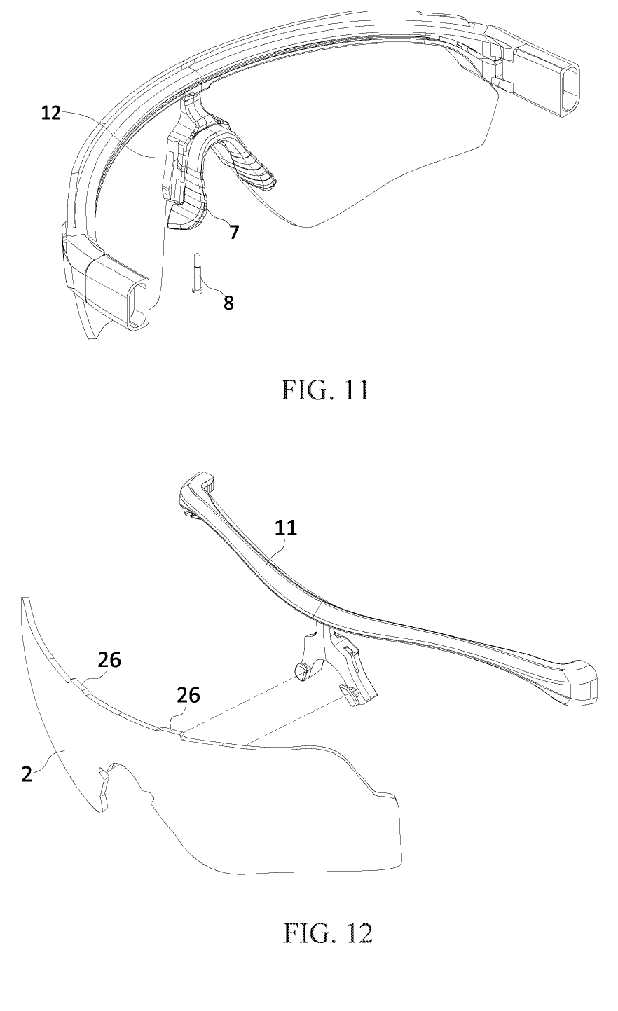

Furthermore, the sporty smart sunglasses of this example further include a nose pad 7. In one embodiment, referring to FIG. 10, a nose pad insertion opening 124 is defined on the inner side of the bridge 12, and a nose pad snap-fit protrusion 71 extends upward from the top of the nose pad 7. The nose pad 7 is embedded within the space defined by the bridge 12, and the nose pad snap-fit protrusion 71 is inserted into the nose pad insertion opening 124. In another embodiment, referring to FIG. 11, a nose pad insertion hole is defined on the bridge 12, and an insertion hole is defined on the nose pad 7. The nose pad 7 is embedded within the space defined by the bridge 12, and the nose pad 7 is connected to the bridge 12 by a screw 8.

In summary, the sporty smart sunglasses of the present example integrate the functions of smart eyewear and sunglasses, allowing users to enjoy music while exercising outdoors, while also providing enhanced eye protection.

Example 2:

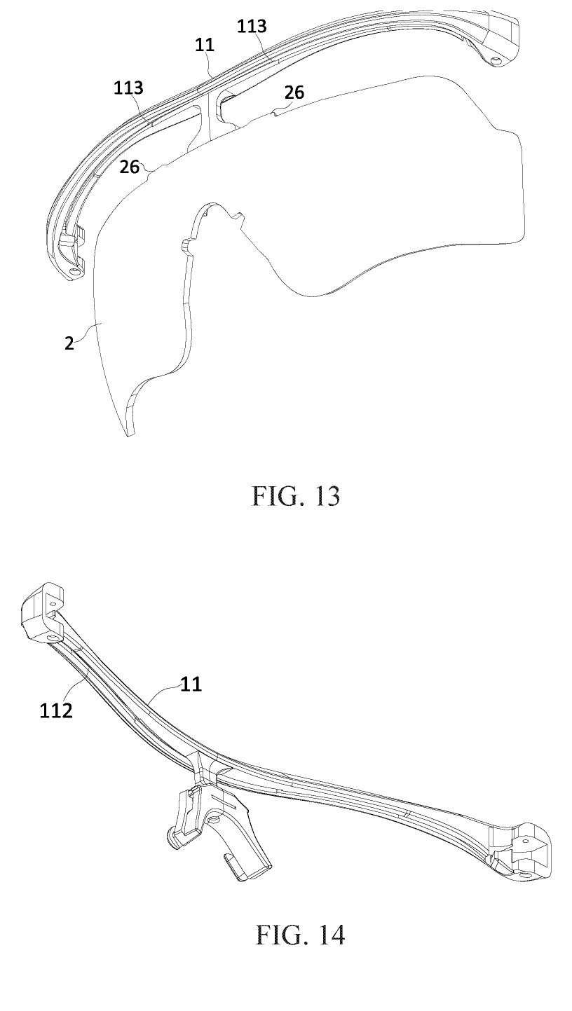

Please refer to FIGS. 12 and 13, which show the sporty smart sunglasses provided in this Example. Compared with the Example 1, the difference is that a snap-fit slot 113 is defined at the bottom of the middle portion of the arched rim 11 in the present Example, and a snap-fit protrusion 26 extends from the edge of the top middle portion of the curved lens 2 at a position corresponding to the snap-fit slot 113. The snap-fit protrusion 26 of the curved lens 2 is snap-fitted to the snap-fit slot 113 of the arched rim 11. After assembly, the curved lens 2 is positioned below the arched rim 11.

The curved lens 2 can be mounted below the arched rim 11 by inserting the snap-fit protrusion 26 of the curved lens 2 upward into the snap-fit slot 113 of the arched rim 11.

In this example, no connecting structures are provided between the left and right ends of the arched rim 11 and the left and right ends of the curved lens 2, and the left and right ends of the arched rim 11 are not in contact with the left and right ends of the curved lens 2.

Please refer to FIG. 14, the cable receiving groove 112 in this example is defined on the bottom surface of the arched rim 11, and the hinge cable assembly 3 is received in the cable receiving groove 112.

Example 3:

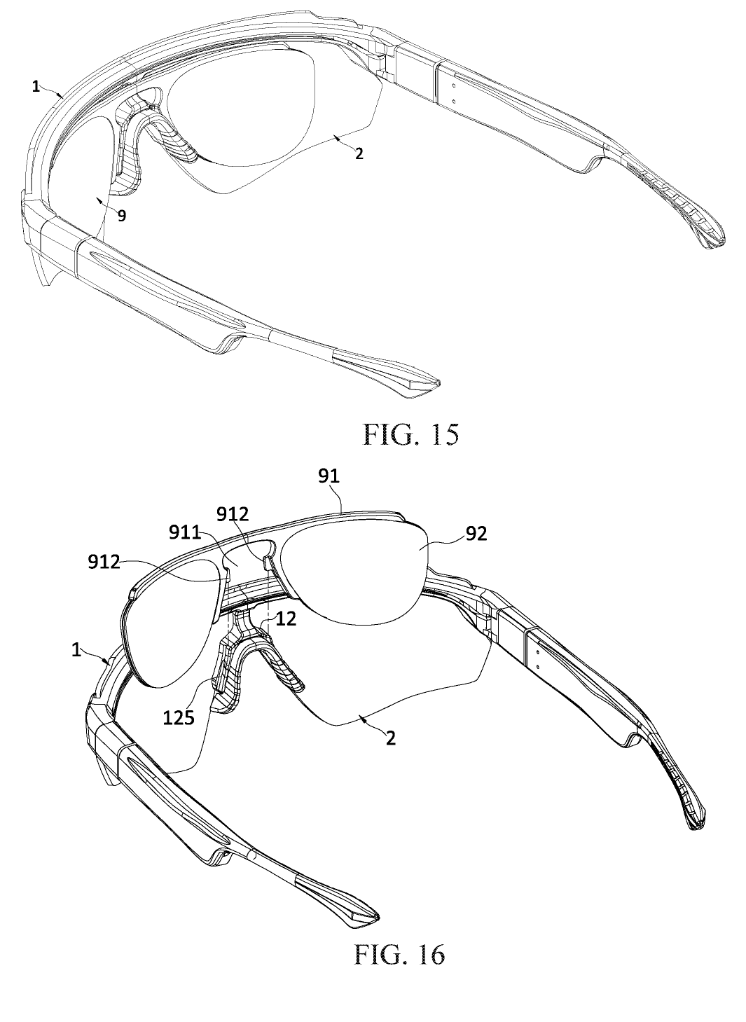

Please refer to FIGS. 15 and 16, which show the sporty smart sunglasses of this example. Compared with the example 1, the difference is that it further includes auxiliary glasses 9. The auxiliary glasses 9 include an auxiliary frame 91 and two auxiliary lenses 92. The two auxiliary lenses 92 are respectively detachably mounted on the left and right sides of the auxiliary frame 91.

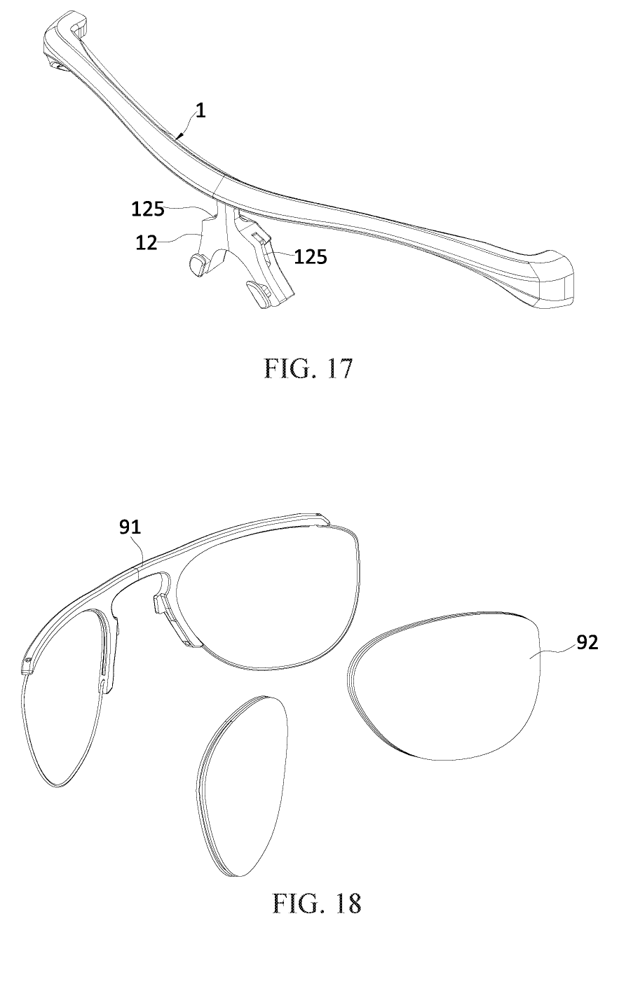

Specifically, in this example, a relief space 911 is defined at a position of the auxiliary frame 91 corresponding to the bridge 12. The auxiliary frame 91 is provided with a protruding lug 912 located at the relief space 911. Referring also to FIG. 17, an insertion slot 125 is defined on the outer side of the bridge 12. By inserting the lug 912 into the insertion slot 125, the auxiliary glasses 9 can be fixedly mounted to the bridge 12 of the frame 1. After being mounted, the auxiliary glasses 9 are located inside the curved lens 2 (that is, the auxiliary glasses 9 are located on the side closer to the eyes compared with the curved lens 2).

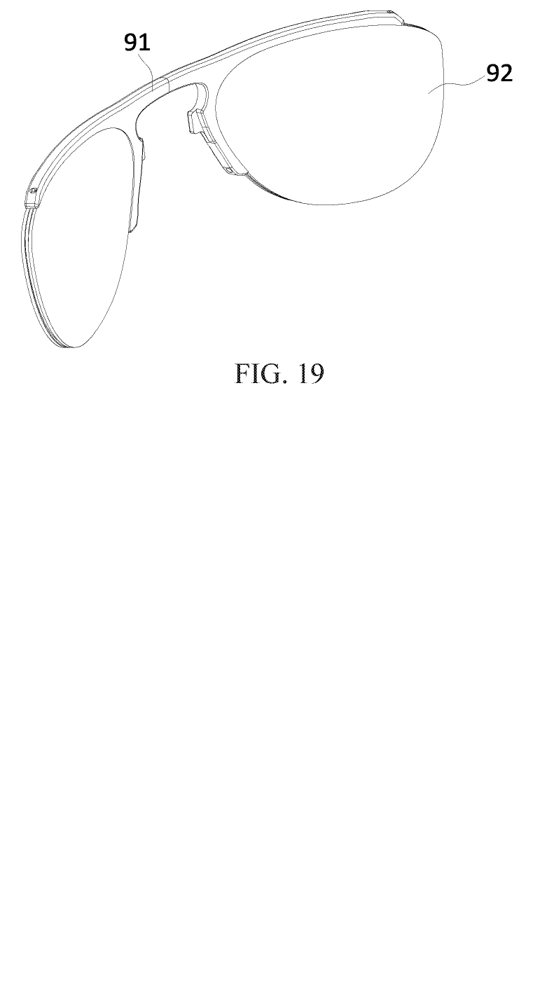

Specifically, the auxiliary glasses 9 may be of a full-frame structure or a half-frame structure. For example, as shown in FIGS. 18 and 19, the upper half of the auxiliary frame 91 is a plastic rim, the lower half is a nylon monofilament plastic coil, and the auxiliary lenses 92 are fitted into the nylon plastic coil.

The sporty smart sunglasses of this example have two glasses, i.e., primary eyeglasses and auxiliary eyeglasses 9. For users with vision correction needs (such as myopia or hyperopia), the primary and auxiliary glasses can be used in combination to satisfy both sun-shading and vision correction requirements.

The foregoing descriptions are merely preferred embodiments and are not intended to limit this disclosure. Any modifications, equivalent replacements, and improvements, and the like made within the spirit and principles of the present disclosure should all fall within the protection scope of this disclosure

What is claimed is:

1. Sporty smart sunglasses, comprising:
a frame;
temples; and
a curved lens, wherein an electronic module for realizing functions of smart glasses is mounted in the frame and/or temples, the curved lens has a sun-shading function and comprises a first lens and a second lens, the first lens and the second lens are of an integral structure, and the curved lens is mounted on the frame via a snap-fit structure.

2. The sporty smart sunglasses according to claim 1, wherein the frame comprises an arched rim, and a bridge extends downward from a middle portion of the arched rim; wherein one or more lens snap-fits are provided on an outer surface of the bridge, a relief notch for avoiding a nose is defined at a bottom of a middle portion of the curved lens, one or more lower recesses are defined at an edge of the relief notch, and the lower recesses of the curved lens are snap-fitted to the lens snap-fits of the bridge, respectively.

3. The sporty smart sunglasses according to claim 2, wherein outer surfaces of left and right ends of the arched rim are respectively provided with snap-fit retainers, upper recesses are respectively defined on left and right side edges of the curved lens, and the upper recesses on the left and right side edges of the curved lens are snap-fitted to the snap-fit retainers at the left and right ends of the arched rim, respectively.

4. The sporty smart sunglasses according to claim 2, wherein a snap-fit slot is defined in a bottom of the arched rim, a snap-fit protrusion extends from a top edge of the curved lens, the snap-fit protrusion of the curved lens is snap-fitted to the snap-fit slot of the arched rim, and left and right ends of the curved lens are not in contact with the left and right ends of the arched rim.

5. The sporty smart sunglasses according to claim 2, wherein the bridge comprises a connecting section and two branch sections, the two branch sections extend outward from a bottom end of the connecting section, and a space defined by the two branch sections is shaped to match the relief notch.

6. The sporty smart sunglasses according to claim 5, wherein the lower recesses are respectively defined on two side edges of the relief notch, and the lens snap-fits are respectively disposed on outer sides of bottom ends of the two branch sections.

7. The sporty smart sunglasses according to claim 5, further comprising a nose pad, wherein a nose pad insertion opening is defined on an inner surface of the bridge, a nose pad snap-fit protrusion extends from a top of the nose pad, the nose pad is embedded within the space defined by the bridge, and the nose pad snap-fit protrusion is inserted into the nose pad insertion opening.

8. The sporty smart sunglasses according to claim 5, further comprising a nose pad, a nose pad mounting hole is defined on the bridge, a mounting hole is defined on the nose pad, the nose pad is embedded within the space defined by the bridge, and the nose pad is connected to the bridge by a screw.

9. The sporty smart sunglasses according to claim 2, further comprising a hinge cable assembly, wherein a cable receiving groove is defined in the arched rim, the hinge cable assembly comprises a cable, a left hinge fixedly connected to a left end of the cable, and a right hinge fixedly connected to a right end of the cable, the cable is embedded in the cable receiving groove, the left hinge is hinged to the left end of the arched rim, and the right hinge is hinged to the right end of the arched rim.

10. The sporty smart sunglasses according to claim 9, wherein the cable receiving groove is defined on an inner surface or bottom surface of the arched rim.

11. The sporty smart sunglasses according to claim 9, further comprising a decorative strip configured to cover and seal the cable receiving groove.

12. The sporty smart sunglasses according to claim 9, wherein the temples comprise a left temple and a right temple, an insertion end of the left temple is inserted into an insertion slot of the left hinge, and an insertion end of the right temple is inserted into an insertion slot of the right hinge.

13. The sporty smart sunglasses according to claim 12, wherein a left sealing ring is wrapped around an outer periphery of the insertion end of the left temple, and an outer periphery of the left sealing ring is in close contact with an inner wall of the insertion slot of the left hinge, a right sealing ring is wrapped around an outer periphery of the insertion end of the right temple, and an outer periphery of the right sealing ring is in close contact with an inner wall of the insertion slot of the right hinge.

14. The sporty smart sunglasses according to claim 2, further comprising auxiliary glasses, wherein the auxiliary glasses comprise an auxiliary frame and two auxiliary lenses, and the two auxiliary lenses are respectively detachably mounted on left and right sides of the auxiliary frame; wherein a relief space is defined at a position of the auxiliary frame corresponding to the bridge, the auxiliary frame is provided with a protruding lug located at the relief space, an insertion slot is defined on an outer surface of the bridge, and the protruding lug is configured to be inserted into the insertion slot.

15. The sporty smart sunglasses according to claim 14, wherein the auxiliary glasses are of a full-frame structure or a half-frame structure.

16. The sporty smart sunglasses according to claim 3, further comprising auxiliary glasses, wherein the auxiliary glasses comprise an auxiliary frame and two auxiliary lenses, and the two auxiliary lenses are respectively detachably mounted on left and right sides of the auxiliary frame; wherein a relief space is defined at a position of the auxiliary frame corresponding to the bridge, the auxiliary frame is provided with a protruding lug located at the relief space, an insertion slot is defined on an outer surface of the bridge, and the protruding lug is configured to be inserted into the insertion slot.

17. The sporty smart sunglasses according to claim 3, further comprising auxiliary glasses, wherein the auxiliary glasses comprise an auxiliary frame and two auxiliary lenses, and the two auxiliary lenses are respectively detachably mounted on left and right sides of the auxiliary frame; wherein a relief space is defined at a position of the auxiliary frame corresponding to the bridge, the auxiliary frame is provided with a protruding lug located at the relief space, an insertion slot is defined on an outer surface of the bridge, and the protruding lug is configured to be inserted into the insertion slot.

18. The sporty smart sunglasses according to claim 4, further comprising auxiliary glasses, wherein the auxiliary glasses comprise an auxiliary frame and two auxiliary lenses, and the two auxiliary lenses are respectively detachably mounted on left and right sides of the auxiliary frame; wherein a relief space is defined at a position of the auxiliary frame corresponding to the bridge, the auxiliary frame is provided with a protruding lug located at the relief space, an insertion slot is defined on an outer surface of the bridge, and the protruding lug is configured to be inserted into the insertion slot.

19. The sporty smart sunglasses according to claim 5, further comprising auxiliary glasses, wherein the auxiliary glasses comprise an auxiliary frame and two auxiliary lenses, and the two auxiliary lenses are respectively detachably mounted on left and right sides of the auxiliary frame; wherein a relief space is defined at a position of the auxiliary frame corresponding to the bridge, the auxiliary frame is provided with a protruding lug located at the relief space, an insertion slot is defined on an outer surface of the bridge, and the protruding lug is configured to be inserted into the insertion slot.

20. The sporty smart sunglasses according to claim 6, further comprising auxiliary glasses, wherein the auxiliary glasses comprise an auxiliary frame and two auxiliary lenses, and the two auxiliary lenses are respectively detachably mounted on left and right sides of the auxiliary frame; wherein a relief space is defined at a position of the auxiliary frame corresponding to the bridge, the auxiliary frame is provided with a protruding lug located at the relief space, an insertion slot is defined on an outer surface of the bridge, and the protruding lug is configured to be inserted into the insertion slot.
